(19) United States
(12) Patent Application Publication
(10) Pub. No.: US 2007/0126222 A1
(43) Pub. Date: Jun. 7, 2007

(54) Steering device

(75) Inventors: Kenji Koya, Takasaki-Shi (JP); Shinichi Fuchigami, Maebashi-Shi (JP)

Correspondence Address: SIDLEY AUSTIN LLP, 717 NORTH HARWOOD, SUITE 3400, DALLAS, TX, 75201, US

(73) Assignee: NSK LTD.

(21) Appl. No.: 11/633,185

(22) Filed: Dec. 4, 2006

(30) Foreign Application Priority Data
Dec. 5, 2005 (JP) 2005-350089
Oct. 12, 2006 (JP) 2006-278204

(51) Int. Cl. B62D 1/18

(52) U.S. Cl. 280/775; 74/493

(57) ABSTRACT

Disclosed herewith is a telescopic type steering device that is high in vibration rigidity and good in feeling of steering has a lower column; an upper column telescopically coupled to the lower column; a steering shaft assembly having an upper axle member for mounting a steering wheel at the upper end and a lower axle member spline-coupled with the upper axle member so as to transmit steering torque to a steering mechanism of a car body from the wheel through the upper and lower axle members; a lower bearing for rotatably supporting the lower axle member at the lower side; an upper bearing for rotatably supporting the upper axle member at the upper side; and an intermediate bearing for rotatably supporting the steering shaft assembly at an intermediate position between the upper and lower bearings.

### FIELD OF THE INVENTION

The present invention relates to a steering device, more particularly to a telescopic type steering device in which an outer column and an inner column are fit to each other slidably in the axial direction to enable telescopic position adjustment of a steering wheel.

### BACKGROUND OF THE INVENTION

There is a telescopic type steering device, which enables telescopic position adjustment of a steering wheel by fitting an outer column and an inner column to each other slidably in the axial direction (US Patent Application Publication No. US 2003/0000330 A1).

In such a steering device, a lower steering shaft is engaged with or fit by a spline or the like to an upper steering shaft that has a steering wheel mounted at the rear side of an object vehicle body to enable telescopic movement and transmit the turning of the steering wheel to a steering gear, thereby changing a steering angle of the wheels of the vehicle.

FIG. 6 shows an expanded cross sectional view of a column of a conventional steering device. As shown in FIG. 6, a lower column (outer column) 1 is fit to a vehicle body 7 by a lower body mounting bracket 61 and by an upper body mounting bracket 62. The outer circumference 21 of the cylindrical upper column (inner column) 2 is fit tightly to the inner circumference 11 of the hollow cylindrical lower column 1 telescopically and slidably in the axial direction.

An upper steering shaft 31 is inserted in the center of the axis of the upper column 2 and the right end (vehicle body's rear side) of the upper steering shaft 31 is journaled rotationally by an upper bearing 41 press-fit to the right end (vehicle body's rear side) of the inner circumference 11 of the upper column 2. A steering wheel 5 is mounted at the right end of the upper steering shaft 31.

A lower steering shaft 32 is inserted in the center of the axis of the inner circumference 11 of the lower column 1 and the left end (vehicle body's front side) of the lower steering shaft 32 is journaled rotationally by a lower bearing 42 press-fit to the left end (vehicle body's front side) of the inner circumference 11 of the lower column 1. A male spline 321 is formed at the right side of the lower steering shaft 32 and the shaft 32 is engaged with a female spline 311 formed at the left side of the upper steering shaft 31.

Consequently, the turning of the steering wheel 5 is transmitted to a steering gear (not shown) through the upper steering shaft 31 and the lower steering shaft 32 to change the steering angle of the vehicle wheels regardless of the telescopic position of the upper column 2.

In the conventional steering device described above, a point of the right end of the upper steering shaft 31 is just journaled rotationally by the upper bearing 41 at the right end of the upper column 2 and a point of the left end of the upper steering shaft 31 is just journaled by the lower bearing 42 at the left end of the lower column 1. Consequently, the space between the upper bearing 41 and the lower bearing 42 becomes large and this structure lowers the vibration rigidity of both the upper steering shaft 31 and the lower steering shaft 32, thereby drivers come feel physical disorder. This is why the conventional steering device is not good for drivers.

### SUMMARY OF THE INVENTION

Under such circumstances it is an object of the present invention to provide a telescopic type steering device with a high vibration rigidity and enabling drivers to have a good feeling of steering respectively.

In order to solve the above described conventional problems, the first aspect of the present invention inheres a steering device, comprising: a lower column; an upper column telescopically coupled to the lower column; a steering shaft for transmitting steering torque to a steering mechanism of a car body from the wheel; a lower bearing for rotatably supporting the steering shaft at the lower side; an upper bearing for rotatably supporting the steering shaft at the upper side; and an intermediate bearing for rotatably supporting the steering shaft at an intermediate position between the upper and lower bearings.

The second aspect of the present invention inheres a steering device, comprising: a lower column; an upper column telescopically coupled to the lower column; a steering shaft assembly having an upper axle member for mounting a steering wheel at the upper end and a lower axle member spline-coupled with the upper axle member so as to transmit steering torque to a steering mechanism of a car body from the wheel through the upper and lower axle members; a lower bearing for rotatably supporting the lower axle member at the lower side; an upper bearing for rotatably supporting the upper axle member at the upper side; and an intermediate bearing for rotatably supporting the steering shaft assembly at an intermediate position between the upper and lower bearings.

The third aspect of the present invention inheres a steering device according to claim 2, wherein; the intermediate bearing supports the lower axle member along with the lower bearing.

The fourth aspect of the present invention inheres a steering device according to claim 3, wherein; the intermediate bearing is mounted in the upper part of the lower column.

The fifth aspect of the present invention inheres a steering device according to claim 3, wherein; the intermediate bearing is mounted in the upper column.

The sixth aspect of the present invention inheres a steering device according to claim 2, wherein; the intermediate bearing supports the upper axle member along with the upper bearing.

The seventh aspect of the present invention inheres a steering device according to claim 6, wherein; the intermediate bearing is mounted in the upper part of the lower column.

The eighth aspect of the present invention inheres a steering device according to claim 6, wherein; the intermediate bearing is mounted in the upper column.

The ninth aspect of the present invention inheres a steering device according to claim 2 to 8, wherein; the lower axle member has a female structure of a coupling and the upper axle member has a male structure of the coupling.

The tenth aspect of the present invention inheres a steering device according to claim 2 to 8, wherein; the lower axle member has a male structure of a coupling and the upper axle member has a female structure of the coupling.

The eleventh aspect of the present invention inheres a steering device according to claim 2 to 8, wherein; a needle bearing is used as the intermediate bearing.

In the steering device of the present invention, the steering shaft assembly is rotatably supported at three points, that is, by lower, intermediate and upper bearings, so that the rigidity against vibration and the feeling of steering are improved.

### BRIEF DESCRIPTION OF THE DRAWINGS

FIG. 1 is an overall perspective view of a steering device 101 mounted on a vehicle;

FIG. 2 is an expanded cross sectional view of a column of the steering device in a first embodiment of the present invention;

FIG. 3 is an expanded cross sectional view of a portion around the intermediate bearing shown in FIG. 2;

FIG. 4 is an expanded cross sectional view of a column of a steering device in a second embodiment of the present invention;

FIG. 5 is an expanded cross sectional view of a column of a steering device in a third embodiment of the present invention; and

FIG. 6 is an expanded cross sectional view of a column of a conventional steering device.

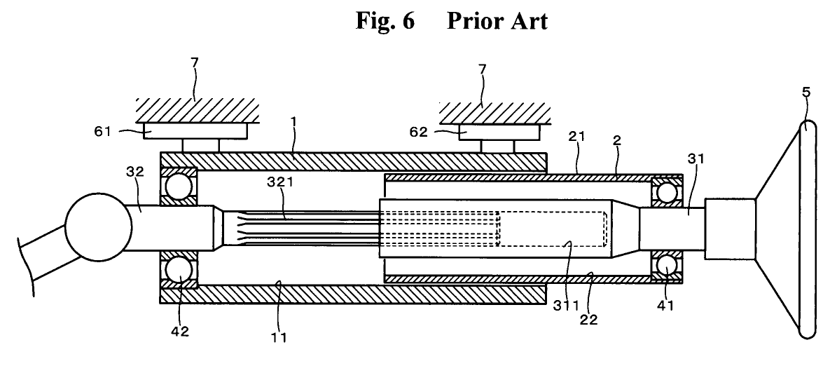

### DETAILED DESCRIPTION OF THE PREFERRED EMBODIMENTS

Hereunder the first and second embodiments of the present invention will be described with reference to the attached drawings.

### First Embodiment

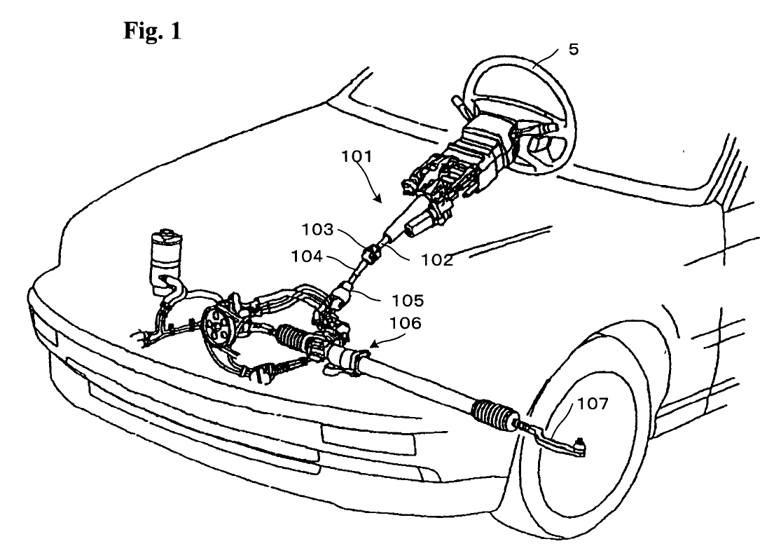

FIG. 1 shows an overall perspective view of a steering device 101 of the present invention, which is mounted on a vehicle. The steering device 101 journals a steering shaft 102 rotationally. The steering shaft 102 has a steering wheel 5 mounted on its top (vehicle body's rear side) and an intermediate shaft 104 linked to its lower end (vehicle body's front side) through a universal joint 103.

The intermediate shaft 104 has a universal joint 105 linked to its lower end and a steering gear composed of a rack and pinion mechanism, etc. is coupled to the universal joint 105.

If a driver turns the steering wheel 5, the turning of the steering wheel 5 is transmitted to a steering gear 106 through the steering shaft 102, the universal joint 103, the intermediate shaft 104, and the universal joint 105, thereby a tie rod 107 is moved through the rack and pinion mechanism to change the steering angle of the vehicle wheels.

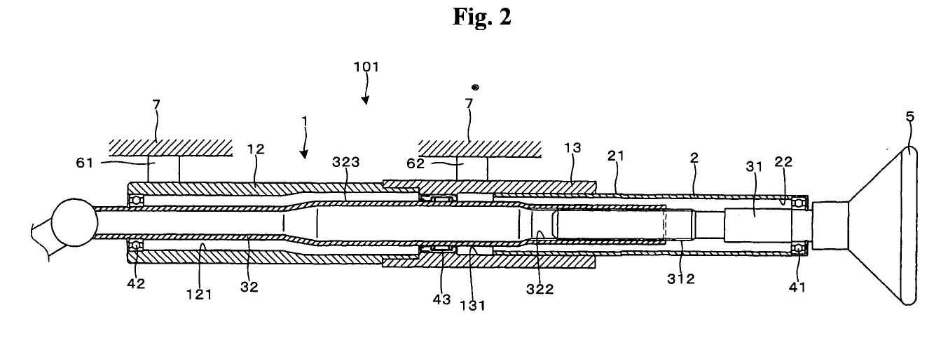

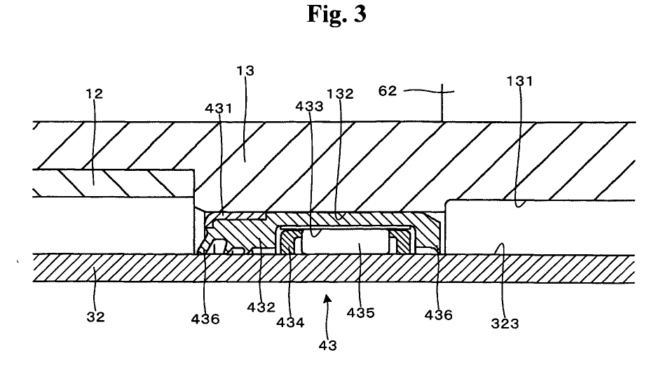

FIGS. 2 and 3 show the steering device in the first embodiment of the present invention respectively. FIG. 2 shows an expanded cross sectional view of a column of the steering device 101 in the first embodiment of the present invention. FIG. 3 shows an expanded view of a portion around the intermediate bearing shown in FIG. 2.

As shown in FIGS. 2 and 3, the lower column (outer column) 1 is composed by press-coupling the body's rear side of the body's front side lower column 12 with the body's front end of the body's rear side lower column 13. The vehicle body's front side lower column 12 is fixed to the vehicle body 7 with a lower body mounting bracket 61 and the vehicle body's rear side lower column 13 is fixed to the vehicle body 7 with an upper vehicle body mounting bracket 62.

To the inner circumference 131 of the vehicle body's rear side lower column 13, the outer circumference 21 of the hollow cylindrical upper column (inner column) 2 is fit tightly, telescopically, and slidably in the axial direction. The vehicle body's rear side lower column 13 has a slit (not shown) formed at a portion where the upper column 2 slides, so that the diameter of the vehicle body's rear side lower column 13 is shrank/expanded with a lever (not shown) to adjust the telescopic position of the upper column 2 at the time of diameter expansion.

An upper steering shaft (inner steering shaft) 31 is inserted in the center of the axis of the upper column 2 and the right end (vehicle body's rear side) of the upper steering shaft 31 is journaled rotationally by an upper bearing 41 press-inserted in the right end (vehicle body's rear side) of the inner circumference 22 of the upper column 2. And a steering wheel 5 is mounted at the right end (vehicle body's rear side) of the upper steering shaft 31. As the upper bearing 41, various types of bearings such as ball bearings, roller bearings, slide bearings, etc. may be used.

The lower steering shaft (outer steering shaft) 32 is inserted in the center of the axis of the inner circumference 121 of the vehicle body's front side lower column 12 and the left end (vehicle body's front side) is journaled rotationally by a lower bearing 42 press-fit to the left end (vehicle body's front side) of the inner circumference 121 of the vehicle body's front side lower column 12. As the lower bearing 42, various types of bearings such as ball bearings, roller bearings, slide bearings, etc. may be used.

A female spline 322 is formed at the right side of the lower steering shaft 32 and the female spline 322 is engaged slidably with a male spline 312 formed at the left side of the upper steering shaft 31. Consequently, the turning of the steering wheel 5 is transmitted to the steering gear (not shown) through the steering wheel 5, the upper steering shaft 31, and the lower steering shaft 32 regardless of the telescopic position of the upper column 2, thereby changing the steering angle of the vehicle wheels.

The right end (vehicle body's rear side) of the lower steering shaft 32 is journaled rotationally by a needle bearing employed as an intermediate bearing. In other words, as shown in FIG. 3, the needle bearing 43 is composed of a thin plate ring-like core metal 431, a rubber or resin cylindrical sealing part 432 united with the core metal 431, and a plurality of needle rollers 435 held by a holder 434 in a ring-like groove 433 of the sealing part 432.

The outer circumferences of both the core metal 431 and the sealing part 432 are press-fit in a bearing hole 132 formed at the vehicle body's front side of the vehicle body's rear side lower column 13, so that the core metal 431 and the sealing part 432 function as outer wheels of the needle bearing 43. The inner diameter of the bearing hole 132 is formed smaller than the inner diameter of the inner circumference 131 of the vehicle body's rear side lower column 13.

The needle roller 435 is fitted outerly to the outer circumference 323 of the lower steering shaft 32 and sealing lips 436 provided at both sides of the inner circumference of the sealing part 432 come into contact with the outer circumference 323 of the lower steering shaft 32 to protect the needle roller 435 from external dust. Consequently, the needle bearing 43 journals the vehicle body's rear end of the lower steering shaft 32 with no play with respect to the vehicle body's rear side lower column 13.

As described above, in the steering device of the present invention, both ends of the lower steering shaft 32 are journaled rotationally at both ends of the lower column 1 by both the lower bearing 42 and the needle bearing 43 that functions as an intermediate bearing. Consequently, both ends of the upper steering shaft 31 engaged with the lower steering shaft 32 by a spline come to be journaled by the needle bearing 43. Therefore the vibration rigidity becomes high in both the upper steering shaft 31 and the lower steering shaft 32 and the turning radium of the vehicle becomes small. The feeling of steering is thus improved.

### Second Embodiment

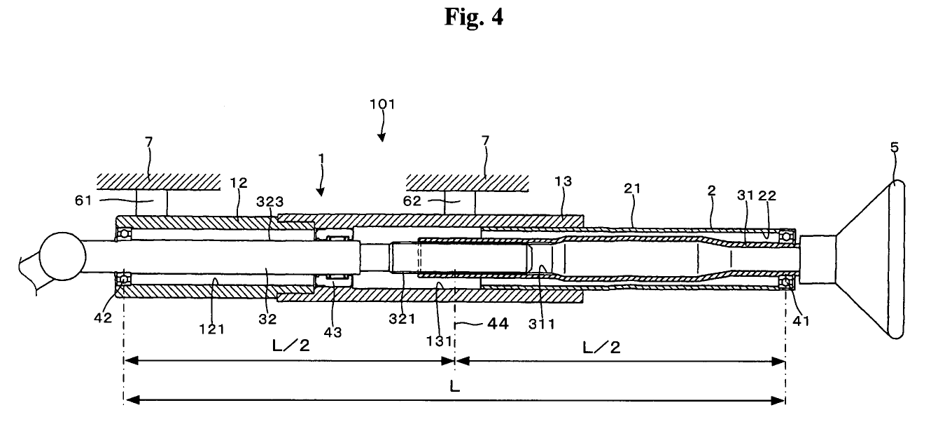

Next, a steering device in a second embodiment of the present invention will be described. FIG. 4 shows an expanded cross sectional view of a column of the steering device 101 in the second embodiment of the present invention. In this second embodiment, only the differences from the first embodiment will be described, avoiding redundancy. In the first embodiment, the outer steering shaft is disposed at the lower side and the inner steering shaft is disposed at the upper side. In the steering device in this second embodiment, however, the outer steering shaft is disposed at the upper side and the lower steering shaft is disposed at the lower side.

As shown in FIG. 4, the upper steering shaft (outer steering shaft) 31 is inserted in the center of the axis of the upper column 2 and the right end (vehicle body's rear side) of the upper steering shaft 31 is journaled rotationally by the upper bearing 41 press-fit to the right end (vehicle body's rear side) of the inner circumference 22 of the upper column 2. And the steering wheel 5 is mounted at the right end (vehicle body's rear side) of the upper steering shaft 31. As the upper bearing 41, various types of bearings such as ball bearings, roller bearings, slide bearings, etc. may be used.

The lower steering shaft (inner steering shaft) 32 is press-fit in the center of the axis of the inner circumference 121 of the vehicle body's front side lower column 12 and the left end (vehicle body's front side) of the lower steering shaft 32 is journaled rotationally by a lower bearing 42 press-fit in the left end (vehicle body's front side) of the inner circumference 121 of the vehicle body's front side lower column 12. As the upper bearing 41, various types of bearings such as ball bearings, roller bearings, slide bearings, etc. may be used.

A male spline 321 is formed at the right side of the lower steering shaft 32 and it is engaged slidably with the female spline 311 formed at the left side of the upper steering shaft 31. Consequently, the turning of the steering wheel 5 is transmitted to the steering gear (not shown) through both the upper steering shaft 31 and the lower steering shaft 32 regardless of the telescopic position of the upper column 2 to change the steering angle of the vehicle wheels.

The right end (vehicle body's rear side) of the lower steering shaft 32 is journaled rotationally by the needle bearing 43 employed as an intermediate bearing. The detailed structure of the needle bearing 43 is the same as that in the first embodiment, so that the description will be omitted here. The needle bearing 43 is disposed closer to the vehicle body's front side than the intermediate position 44 of an interval L in the axial direction between the upper bearing 41 and the lower bearing 42 regardless of the position for telescopic adjustment of the upper column 2.

Also in the steering device in this second embodiment, both ends of the lower steering shaft 32 are journaled rotationally at both ends of the lower column 1 by the lower bearing 42 and the needle bearing 43. Consequently, both ends of the upper steering shaft 31 engaged with the lower steering shaft 32 by a spline are also journaled by the upper bearing 41 and by the needle bearing 43. Thus the vibration rigidity is high in both the upper steering shaft 31 and the lower steering shaft 32. In addition, the turning radius of the vehicle becomes small, thereby the feeling of steering is improved.

If a vertical force is applied to the steering wheel 5, the upper steering shaft 31 begins rotating at a fulcrum assumed at the upper bearing 41. However, because the needle bearing 43 is disposed toward the vehicle body's front side far from the upper bearing 41, the turning of the upper steering shaft 31 is suppressed. The feeling of steering is thus improved.

### Third Embodiment

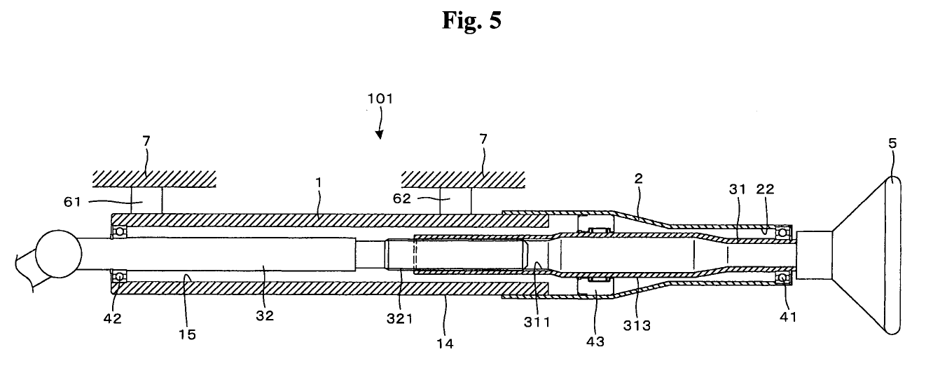

Next, a steering device in a third embodiment of the present invention will be described. FIG. 5 shows an expanded cross sectional view of a column of the steering device 101 in the third embodiment of the present invention. In this embodiment, only the differences from the above embodiments will be described, avoiding redundancy. In the steering device in this third embodiment, a lower column and an upper column formed as one item respectively are used as an inner column and an outer column respectively. And a needle bearing is provided at the upper column side.

As shown in FIG. 5, the lower column (inner column) 1 is formed as one item and the vehicle body's front side of the lower column 1 is fixed to the vehicle body 7 with a lower vehicle body mounting bracket 61 while the vehicle body's rear side of the lower column 1 is fixed to the vehicle body 7 with an upper vehicle body mounting bracket 62.

The vehicle body's front side of the inner circumference 22 of the hollow cylindrical upper column (outer column) 2 is fit to the vehicle body's rear side of the outer circumference 14 of the hollow cylindrical lower column 1 tightly, telescopically, and slidably in the axial direction. The upper column 2 has a slit (not shown) formed at a spot where the upper column 2 is fit outerly to the lower column 1. The diameter of the upper column 2 is shrank/expanded with a lever (not shown) to adjust the telescopic position of the upper column 2 at the time of diameter expansion.

As shown in FIG. 5, the upper steering shaft (outer steering shaft) 31 is inserted in the center of the axis of the upper column 2 formed as one item and the right end (vehicle body's rear side) of the inner circumference 22 of the upper column 2 is journaled rotationally by the upper bearing 41 press-fit to the right end (vehicle body's rear side) of the inner circumference 22 of the upper column 2. And a steering wheel 5 is fixed to the right end (vehicle body's rear side) of the upper steering shaft 31. As the upper bearing 41, various types of bearings such as ball bearings, roller bearings, slide bearings, etc. may be used.

The lower steering shaft (inner steering shaft) 32 is inserted in the center of the axis of the inner circumference 15 of the lower column 1 formed as one item and the left end (vehicle body's front side) of the lower steering shaft 32 is journaled rotationally by the lower bearing 42 press-fit to the left end (vehicle body's front side) of the inner circumference 15 of the lower column 1. As the lower bearing 42, various types of bearings such as ball bearings, roller bearings, slide bearings, etc. may be used.

A male spline 321 is formed at the right side of the lower steering shaft 32 and it is engaged slidably with a female spline 311 formed at the left side of the upper steering shaft 31. Consequently, the turning of the steering wheel 5 is transmitted to the steering gear (not shown) through the upper steering shaft 31 and the lower steering shaft 32 regardless of the telescopic position of the upper column 2 to change the steering angle of the vehicle wheels.

The outer circumference 313 of the vehicle body's front side of the upper steering shaft 31 is journaled rotationally to the vehicle body's front side of the inner circumference 22 of the upper column by a needle bearing 43 employed as an intermediate bearing. The detailed structure of the needle bearing 43 is the same as that in the first embodiment, so that the description will be omitted here.

Also in the steering device in this third embodiment, both sides of the upper steering shaft 31 are journaled rotationally at both ends of the upper column 2 by the upper bearing 41 and the needle bearing 43. Consequently, both ends of the lower steering shaft 32 engaged with the upper steering shaft 31 by a spline come to be journaled by the lower bearing 42 and by the needle bearing 43. Thus the vibration rigidity is high in both the upper steering shaft 31 and the lower steering shaft 32. In addition, the turning radium of the vehicle becomes small and the feeling of steeling is improved.

In the third embodiment, the present invention is applied to a steering device that enables telescopic position to be adjusted manually. However the present invention may also be applied to a steering device that enables telescopic position to be adjusted by an electric-driven actuator. Furthermore, if a distance bracket is attached to the outer circumference of the outer column or inner column and this distance bracket is disposed between vehicle body mounting brackets, the present invention may be applied to a steering device that clamps/unclamps the telescopic position.

In the above embodiments, the present invention is applied only to a steering device that adjusts telescopic positions. However the present invention may also be applied to a steering device that can adjust both telescopic positions and tilting positions. In addition, the present invention may be applied to a steering device that absorbs an impact load by enabling the outer column and the inner column to slide relatively in the axial direction, then the steering wheel to the vehicle body's front side as a collapse movement at a secondary collision.

Furthermore, in the above embodiments, the steering shaft is divided into an upper steering shaft 31 and a lower steering shaft 32, both of which can make telescopic movement. However the steering shaft may be formed as one item. If the steering shaft is formed as one item, the steering shaft can move relatively with respect to the lower bearing 42. Furthermore, it is also possible to assume the lower column as an inner column and the upper column as an outer column to divide the upper column into two parts in the axial direction, then provide an intermediate bearing at the divided upper column side. Furthermore, the outer column may be divided into two parts in the axial direction. In this case, an intermediate bearing may be provided at the divided inner column side.

Furthermore, in the above embodiments, the lower column 1 is composed of the vehicle body's front side lower column 12 and the vehicle body's rear side lower column 12 that are press-fit to each other. However the lower column 1 may be formed as one item. In addition, the material of both the lower column 1 and the upper column 2 may not be limited only to iron; it may be another material such as aluminum. The intermediate bearing may not be limited only to the needle bearing described above; it may be any of ball bearing and slide bearings.

1. A steering device, comprising:
a lower column;
an upper column telescopically coupled to the lower column;
a steering shaft for transmitting steering torque to a steering mechanism of a car body from the wheel;
a lower bearing for rotatably supporting the steering shaft at the lower side;
an upper bearing for rotatably supporting the steering shaft at the upper side; and
an intermediate bearing for rotatably supporting the steering shaft at an intermediate position between the upper and lower bearings.

2. A steering device, comprising:
a lower column;
an upper column telescopically coupled to the lower column;
a steering shaft assembly having an upper axle member for mounting a steering wheel at the upper end and a lower axle member spline-coupled with the upper axle member so as to transmit steering torque to a steering mechanism of a car body from the wheel through the upper and lower axle members;
a lower bearing for rotatably supporting the lower axle member at the lower side;
an upper bearing for rotatably supporting the upper axle member at the upper side; and
an intermediate bearing for rotatably supporting the steering shaft assembly at an intermediate position between the upper and lower bearings.

3. A steering device according to claim 2, wherein;
the intermediate bearing supports the lower axle member along with the lower bearing.

4. A steering device according to claim 3, wherein;
the intermediate bearing is mounted in the upper part of the lower column.

5. A steering device according to claim 3, wherein;
the intermediate bearing is mounted in the upper column.

6. A steering device according to claim 2, wherein;
the intermediate bearing supports the upper axle member along with the upper bearing.

7. A steering device according to claim 6, wherein;
the intermediate bearing is mounted in the upper part of the lower column.

8. A steering device according to claim 6, wherein;
the intermediate bearing is mounted in the upper column.

9. A steering device according to any of claims 2 to 8, wherein;
the lower axle member has a female structure of a coupling and the upper axle member has a male structure of the coupling.

10. A steering device according to any of claims 2 to 8, wherein;
the lower axle member has a male structure of a coupling and the upper axle member has a female structure of the coupling.

11. A steering device according to any of claims 2 to 8, wherein;
a needle bearing is used as the intermediate bearing.
